(19) United States
(12) Patent Application Publication
(10) Pub. No.: US 2020/0145733 A1
(43) Pub. Date: May 7, 2020

(54) ELECTRONIC INSTRUMENT, NON-TRANSITORY COMPUTER-READABLE STORAGE MEDIUM, CONTROL DEVICE, AND CONTROL METHOD

(71) Applicant: SHARP KABUSHIKI KAISHA, Sakai City, Osaka (JP)

(72) Inventors: MEGUMI YOKOGAWA, Sakai City, Osaka (JP); TADAO ANDOH, Sakai City, Osaka (JP); KIYOFUMI OHTSUKA, Sakai City, Osaka (JP)

(21) Appl. No.: 16/606,035

(22) PCT Filed: Apr. 6, 2018
(86) PCT No.: PCT/JP2018/014802

§ 371 Date: Oct. 17, 2019

(30) Foreign Application Priority Data
May 31, 2017 (JP) 2017-108762
Aug. 10, 2017 (JP) 2017-155908

(51) Int. Cl. H04N 21/81; G06F 3/0481; G08B 6/00; H04N 21/422; H04N 21/4788

(52) U.S. Cl. CPC H04N 21/8186; G06F 3/0481; H04N 21/4788; H04N 21/42201; H04N 21/42222; G08B 6/00

(57) ABSTRACT

The present invention allows, without hindering a user from cheering, the user to obtain information at an appropriate timing at which the user wishes to obtain the information. The present invention includes: a motion detecting section (111) which detects a viewing motion in which the user views a display device (12) of a wearable terminal (10); and a display detail determining section (113) which, in a case where the motion detecting section has detected the viewing motion, causes the display device (12) to

### TECHNICAL FIELD

The present invention relates to an electronic apparatus, a program, a control device, and a control method.

### BACKGROUND ART

Conventionally, there has been researched and developed an electronic apparatus which estimates a feeling of a user from, for example, a facial expression of the user and then outputs an image, a voice message, and/or the like that appropriately respond(s) to the feeling thus estimated. For example, Patent Literature 1 discloses an electronic apparatus which includes (i) a user state analyzing section which analyzes a state of a user, (ii) a content information analyzing section which analyzes a state of content, (iii) a comment creating section which creates, in accordance with the analyzed state of the user and the analyzed state of the content, a comment that is expected to gain a favorable response from the user, and (iv) a comment outputting section which outputs, in a form of, for example, a sound, the comment thus created.

### CITATION LIST

### [Patent Literature]

### [Patent Literature 1]

Japanese Patent Application Publication Tokukai No. 2016-186741 (Publication date: Oct. 27, 2016)

### SUMMARY OF INVENTION

### Technical Problem

The electronic apparatus disclosed in Patent Literature 1 outputs, at a timing at which content is received, information (e.g., a comment) that is created in accordance with the state of the user. Note, however, that the electronic apparatus has a problem of preventing the user from obtaining information at an appropriate timing which does not hinder the user from cheering.

For example, the user who is moving his/her hand(s) and/or leg(s) while concentrating on cheering may unfortunately miss information (e.g., a comment) which has been notified to the electronic apparatus. This may result in waste of electric power consumed to carry out such a process as described earlier (i.e., a process for outputting information and notifying the information to the electronic apparatus). Furthermore, the electronic apparatus which causes the user to more strongly sense an interruption so as not to miss a notification more seriously hinders current cheering. This obstructs cheering. It is therefore necessary to notify the user of information at an appropriate timing which does not hinder the user from cheering.

An object of an aspect of the present invention is to provide, for example, an electronic apparatus which, without hindering a user from cheering, allows the user to obtain information at an appropriate timing at which the user wishes to obtain the information.

### Solution to Problem

In order to attain the above object, an electronic apparatus in accordance with an aspect of the present invention includes: at least one motion detecting device; at least one display device; and at least one control device, in a case where the at least one motion detecting device has detected a viewing motion in which a user views the at least one display device of the electronic apparatus, the at least one control device causing the at least one display device to display information.

In order to attain the above object, a control device in accordance with an aspect of the present invention is a control device for controlling an electronic apparatus, the control device including: a motion detecting section which detects a viewing motion in which a user views a display device of the electronic apparatus; and a display control section which, in a case where the motion detecting section has detected the viewing motion, causes the display device to display information.

In order to attain the above object, a method for controlling an electronic apparatus in accordance with an aspect of the present invention is a method for controlling an electronic apparatus including at least one display device, the method including the steps of: (a) detecting a viewing motion in which a user views the at least one display device of the electronic apparatus; and (b) in a case where the viewing motion has been detected in the step (a), causing the at least one display device to display information.

### Advantageous Effects of Invention

An electronic apparatus and the like in accordance with an aspect of the present invention yield an effect of, without hindering a user from cheering, allowing the user to obtain information at an appropriate timing at which the user wishes to obtain the information.

### BRIEF DESCRIPTION OF DRAWINGS

FIG. 1 is a block diagram illustrating a configuration of a main part of a wearable terminal in accordance with an embodiment of the present invention.

FIG. 2 is a block diagram schematically illustrating a configuration of a sport cheering system in accordance with an embodiment of the present invention.

FIG. 3 is a diagram illustrating an appearance of the wearable terminal.

FIG. 4 is a flowchart showing an example of a control method in accordance with an embodiment of the present invention.

### DESCRIPTION OF EMBODIMENTS

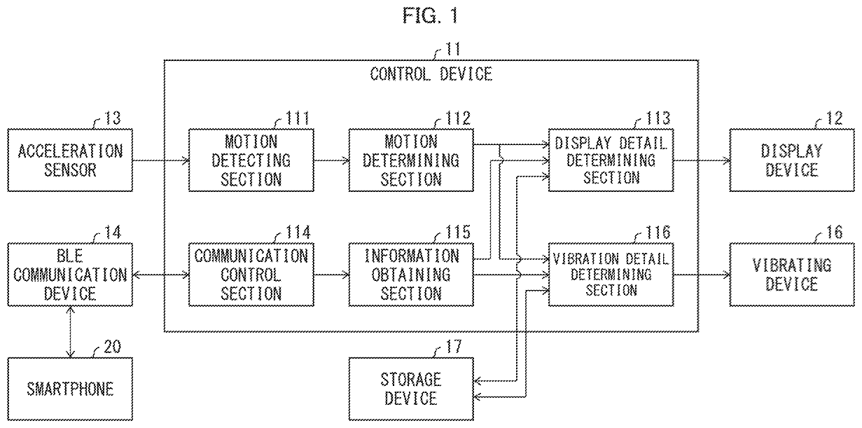

An embodiment of the present invention is specifically described below with reference to FIGS. 1 through 4. For convenience, members having functions identical to those of the respective members described in a specific section are given respective identical reference signs, and a description of those members is omitted here.

Note that the following description takes a wristwatch type wearable terminal as an example of an electronic apparatus in accordance with an aspect of the present invention. The electronic apparatus in accordance with an aspect of the present invention can be exemplified not only by the wristwatch type wearable terminal but also by a wristband type wearable terminal. Note, however, that the present invention is applicable not only to such a wearable terminal but also to, for example, (i) an electronic apparatus similar to a srnartphone, an eyeglass type electronic apparatus, and (iii) a stick type electronic apparatus.

According to the following embodiment, the electronic apparatus in accordance with an aspect of the present invention can include one or more control devices, one or more display devices, and other one or more devices.

### <Outline of Configuration of Sport Cheering System>

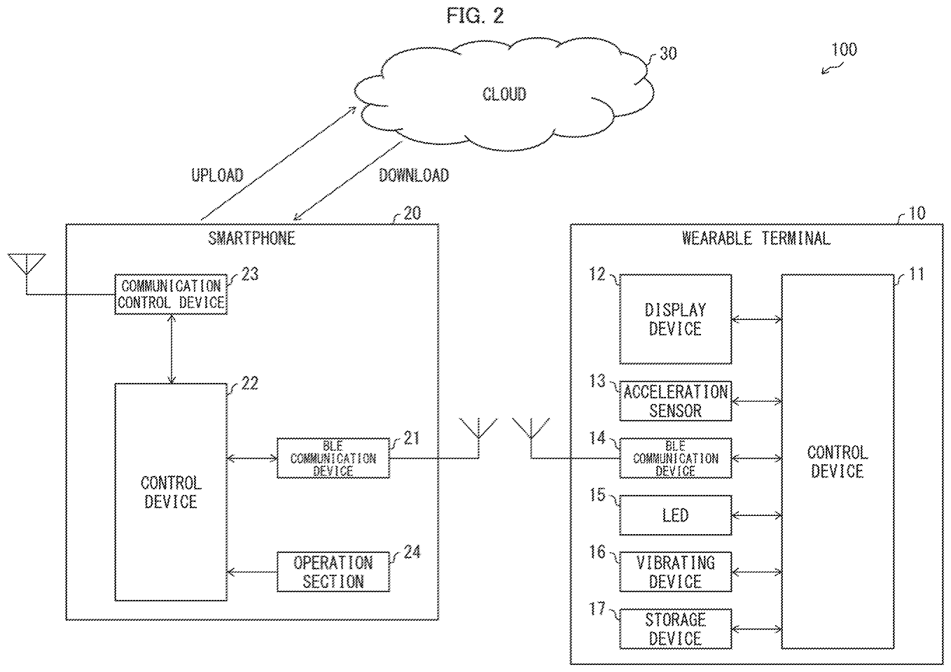

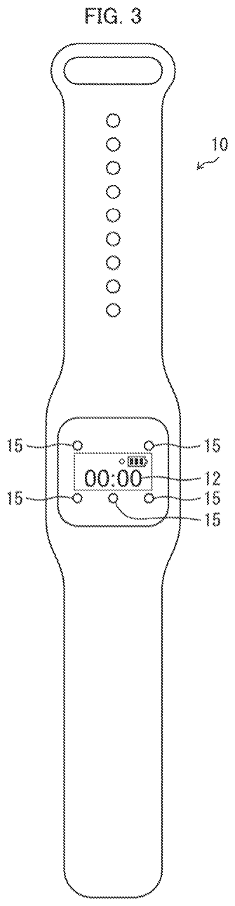

First, the following description schematically discusses, with reference to FIG. 2, a configuration of a sport cheering system 100 in accordance with an embodiment of the present invention. FIG. 2 is a block diagram schematically illustrating the configuration of the sport cheering system 100. FIG. 3 is a diagram illustrating an appearance of a wearable terminal (electronic apparatus) 10.

The sport cheering system 100 is a system which assists a user who watches a sport at or near a stadium in actively cheering for the sport. Note here that the term “near a stadium” assumes that the user watches the sport through a large screen monitor which is provided in, for example, an open space near the stadium. As illustrated in FIG. 2, the sport cheering system 100 includes the wearable terminal 10, a smartphone 20, and a cloud 30.

The wearable terminal 10, which is a wristwatch type terminal as illustrated in FIG. 3, is an information terminal which can be carried around with the user while being worn on a wrist (body) of the user. More specifically, the wearable terminal 10 is a wearable apparatus which is used while being worn on the wrist (body) of the user who watches a sport such as baseball or soccer. The wearable terminal 10 is an apparatus for allowing the user to have more fun of cheering. Specifically, in order for the user to have more fun of cheering, the wearable terminal 10 causes an acceleration sensor 13 to sense a cheering gesture which is made during sports watching and gives feedback to LEDs 15, a display device 12, and a vibrating device 16 in accordance with details of the cheering gesture sensed.

The wearable terminal 10 also has various functions for assisting the user in cheering for a sport. As illustrated in FIGS. 2 and 3, the wearable terminal 10 includes a control device 11, the display device 12, the acceleration sensor (motion detecting device) 13, a BLE communication device 14, the LEDs 15, the vibrating device 16, and a storage device 17. The term “LED” is an abbreviation for Light Emitting Diode. The term “BLE” is an abbreviation for Bluetooth (registered trademark) Low Energy.

The control device 11 collectively controls the devices of the wearable terminal 10 and sections of the wearable terminal 10. The display device 12, which is, for example, a liquid crystal display (LCD), visualizes and displays information (e.g., respective names of a pitcher and a batter) based on data that is not obtainable at the stadium. As illustrated in FIG. 3, the display device 12 also displays the time and a remaining battery level. The acceleration sensor 13 senses a vibration of the wearable terminal 10. The BLE communication device 14 is a device for carrying out short range radio communication between the wearable terminal 10 and the smartphone 20. Same applies to a BLE communication device 21 (described later).

The LEDs 15 present a cheering state of the user in accordance with a change, caused by the control device 11, in color of emitted light and intensity of light. As illustrated in FIG. 3, five LEDs 15 are provided so as to surround the display device 12. Specifically, the five LEDs 15 are provided as follows. Two of the five LEDs 15 are provided in bilateral symmetry in a region above the display device 12 as a viewer of FIG. 3 faces the front of the display device 12. Other two of the five LEDs 15 are provided in bilateral symmetry in a region below the display device 12 as the viewer of FIG. 3 faces the front of the display device 12. The remaining one of the five LEDs 15 is provided between the two LEDs 15 which are provided in the region below the display device 12. Note that it can be arbitrarily changed how many LEDs 15 to provide and how to provide the LEDs 15.

The vibrating device 16, which is, for example, a vibrator, presents the cheering state of the user in accordance with a change, caused by the control device 11, in type of vibration and in strength of a vibration. The storage device 17 stores therein, in advance, information which is necessary for an operation of the smartphone 20, or stores therein, at any time, information. which is generated in accordance with the operation of the smartphone 20.

The smartphone 20 is a multi-function mobile phone which simultaneously has functions of, for example, a personal computer and a personal digital assistant (PDA) (mobile information terminal). The smartphone 20 includes the BLE communication device 21, a control device 22, communication control device 23, and an operation section 24.

The control device 22 collectively controls the devices of the smartphone 20 and sections of the smartphone 20. The communication control device 23 is a device for exchanging (uploading and downloading) data between the smartphone 20 and the cloud 30. The operation section 24 receives an operation which the user carries out with respect to the smartphone 20. The operation section 24 in accordance with the present embodiment receives, for example, an operation to set an operating mode of the smartphone 20 (sport cheering system 100). For example, the user sets the operating mode of the smartphone 20 to, for example, an operating mode in which various pieces of information to be transmitted from the smartphone 20 to the wearable terminal 10 is limited in advance to information on a user's favorite team.

The cloud 30 is a server in which various pieces of data on the user's favorite team and a user's favorite player are stored and via which the various pieces of data are exchanged between the wearable terminal 10 and the smartphone 20. The user who uses, via the smartphone 20, results of various processes carried out by the control device 11 of the wearable terminal 10 and (ii) the various pieces of data (described earlier) stored in the cloud 30 can fully enjoy cheering for a sport at the stadium.

The present embodiment is configured such that the sport cheering system 100 includes the wearable terminal 10 as a constituent thereof. Note, however, that the present embodiment does not necessarily need to be thus configured. For example, the present embodiment can alternatively be configured such that the wearable terminal 10 alone achieves a data exchange carried out in the sport cheering system 100.

The description of the present embodiment shows, as an example of a motion, a cheering motion, which is a friendly gesture toward a specific target. Note, however, that the motion of the present embodiment is not limited to the cheering motion. Alternatively, the motion of the present embodiment can be, for example, an unfriendly motion toward an unfavorite team or an unfriendly motion also toward a favorite team. Further alternatively, the motion of the present embodiment can be a motion which is made by a movement of the body of the user as a whole, instead of a motion which is made by a movement of the body of the user during sports watching.

### <Functional Configuration of Control Device>

Next, the following description discusses, with reference to FIG. 1, a configuration of a main part of the wearable terminal 10. FIG. 1 is a block diagram illustrating the configuration of the main part of the wearable terminal 10. As illustrated in FIG. 1, the control device 11 includes a motion detecting section 111, a motion determining section 112 (motion detecting section), a display detail determining section (display control section) 113, a communication control section 114, an information obtaining section 115, and a vibration detail determining section 116.

The motion detecting section 111 detects, in accordance with a sensing result obtained from the acceleration sensor 13, a gesture which is made by the user. The motion determining section 112 makes, in accordance with, for example, a result of detection by the motion detecting section 111, a determination whether a user's gesture, which is the result of detection, falls under a viewing motion in which the user views the display device 12 of the wearable terminal 10. The determination can be made by determining whether the acceleration sensor 13 has sensed a specific twisting gesture.

The display detail determining section 113 determines details of information to be displayed in the display device 12 and then carries out control so as to cause the display device 12 to display the information. For example, in a case where a batter in a batter's box has been struck out during a baseball game in progress, the display device displays text information “STRIKEOUT”.

In a case where the user views the display device 12 of the wearable terminal 10 while a pitcher and a batter are facing each other, the display device 12 displays not only respective names of the pitcher and the batter, which names are obtainable at the stadium, but also, for example, a record of the pitcher against the batter and a record of the batter against the pitcher, batting results of the day on which the game is held, and/or a best pitch of the pitcher. This makes it possible to easily check information based on data that is ordinarily unobtainable at the stadium. Examples of the information to be displayed in the display device 12 include not only information on the pitcher and the batter but also, for example, a base stealing average of a runner who is on base. Examples of the information to be displayed. in the display device 12 also include not only such data-based. information but also information (e.g., lyrics of a song which is sung for cheering for the batter) which allows the user to have fun of cheering. The vibration detail determining section 116 determines, in accordance with information obtained by the information obtaining section 115, how the vibrating device 16 vibrates.

In a case where the acceleration sensor (motion detecting device) 13 senses a specific motion of the user (e.g., a cheering motion which the user makes in cheering for a sport), the control device 11 can either causes the display device 12 to display no information or causes the display device 12 to maintain a current display. This allows no unnecessary information to be displayed while the user is cheering.

The control device 22 of the smartphone 20 can estimate a preference of the user by obtaining, for each user, from the wearable terminal 10 via the BLE communication device 21, (a) information (time of viewing) indicating what information the user viewed and how long the user viewed that information and/or (b) information (frequency of viewing) indicating in what situation the user made, many times, a gesture of checking a display and (ii) analyzing the information (a) and/or the information (b). That is, the control device 22 can estimate the preference of the user in accordance with (i) a frequency of the viewing motion, (ii) a duration of the viewing motion, and (iii) a timing of detection of the viewing motion. This makes it possible to estimate the preference of the user in accordance with, for example, how often the user views the display device 12

For example, in a case where the user browses (views) information on a specific team for a long time, the user can be expected to be a fan of the specific team. Similarly, in a case where the user browses information on a specific player for a long time or causes such information to be displayed many times, the user can be expected to be a fan of the specific player.

According to the wearable terminal 10, a natural and simple gesture of viewing the display device 12 triggers a display of information in the display device 12. This makes it possible to, without hindering the user from cheering, allow the user to obtain information at an appropriate timing at which the user wishes to obtain the information.

Furthermore, in a case where a preference of the user is determined, without the need for the user to set the preference, in accordance with, for example, a time for which the user browses information, a timing at which the user browses information, and/or the number of times the user checks a display, the user can be gradually notified of information which is more suitable to the preference of the user. This allows an apparatus, which merely notified generic information in initial use, to be customized to a preference of the user as the user uses the apparatus more times.

Assume that the user is found to have a tendency to less frequently view a display during a first half of a game. In this case, in order for the user to further concentrate on watching the game, it is possible to make an adjustment to reduce the number of times of notification (display of information in the display device 12) during the first half of the game.

### <Operation of Sport Cheering System>

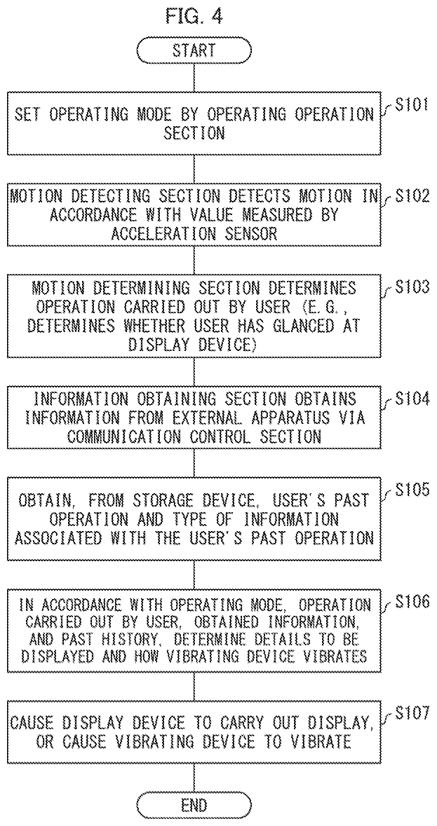

Next, the following description discusses, with reference to FIG. 4, an example of an operation (control method) which the sport cheering system 100 carries out. FIG. 4 is a flowchart showing an example of a control method in accordance with an embodiment of the present invention.

In a step S (“step” is hereinafter omitted) 101, the user sets an operating mode via the operation section 24 of the smartphone 20. Then, the process proceeds to S102. In S102, the motion detecting section 111 detects a motion in accordance with a value measured by the acceleration sensor 13. Then, the process proceeds to S103.

In S103, the motion determining section 112 determines an operation carried out by the user (e.g., determines whether the user has glanced at (viewed) the display device 12). Then, the process proceeds to S104. In S104, the information obtaining section 115 obtains information from an external apparatus (smartphone 20) via the communication control section 114. Then, the process proceeds to S105.

In S105, the information obtaining section 115 obtains, from the storage device 17, a user's past operation and a type of information associated with the user's past operation. Then, the process proceeds to S106. In S106, in accordance with (i) the operating mode, (ii) the operation carried out by the user, (iii) obtained information, and (iv) a past history, the display detail determining section 113 determines details to be displayed in the display device 12, and the vibration detail determining section 116 determines how the vibrating device 16 vibrates. Then, the process proceeds to S107.

In S107, the display detail determining section 113 causes the display device 12 to display information whose details have been determined in S106, and the vibration detail determining section 116 causes the vibrating device 16 to vibrate in accordance with what has been determined in S106, i.e., how the vibrating device 16 vibrates. Then, the process ends.

### [Software Implementation Example]

Control blocks of the control device 11 (particularly, the motion detecting section 111, the motion determining section 112, the display detail determining section 113, the communication control section 114, the information obtaining section 115, and the vibration detail determining section 116) can be realized by a logic circuit (hardware) provided in an integrated circuit (IC chip) or the like or can be alternatively realized by software.

In the latter case, the control device 11 includes a computer that executes instructions of a program that is software realizing the foregoing functions. The computer, for example, includes at least one processor and a computer-readable storage medium storing the program. An object of the present invention can be achieved by the processor of the computer reading and executing the program stored in the storage medium. Examples of the processor encompass a central processing unit (CPU). Examples of the storage medium encompass a “non-transitory tangible medium” such as a read only memory (ROM), a tape, a disk, a card, a semiconductor memory, and a programmable logic circuit. The computer may further include a random access memory (RAM) or the like in which the program is loaded. Further, the program may be made available to the computer via. any transmission medium (such as a communication network and a broadcast wave) which allows the program to be transmitted. Note that an aspect of the present invention can also be achieved in the form of a computer data signal in which the program is embodied via electronic transmission and which is embedded in a carrier wave.

Aspects of the present invention can also be expressed as follows:
An electronic apparatus in accordance with a first aspect of the present invention includes: at least one motion detecting device; at least one display device; and at least one control device, in a case where the at least one motion detecting device has detected a viewing motion in which a user views the at least one display device of the electronic apparatus, the at least one control device causing the at least one display device to display information. According to the configuration, a natural and simple gesture of viewing the display device triggers a display of information in the display device. This makes it possible to, without hindering the user from cheering, allow the user to obtain information at an appropriate tinning at which the user wishes to obtain the information.

In a second aspect of the present invention, an electronic apparatus can be configured such that, in the first aspect of the present invention, the at least one control device estimates a preference of the user in accordance with a frequency of the viewing motion, a duration of the viewing motion, and (iii) a timing of detection of the viewing motion. The configuration makes it possible to estimate the preference of the user in accordance with, for example, how often the user views the display device.

In a third aspect of the present invention, an electronic apparatus can be configured such that, in the first aspect of the present invention, in a case where the at least one motion detecting device has detected a specific motion of the user, the at least one control device either causes the at least one display device to display no information or causes the at least one display device to maintain a current display. The configuration allows no unnecessary information to be displayed while the user is cheering.

A control device included in an electronic apparatus in accordance with the foregoing aspects of the present invention may be realized by a computer. In this case, the present invention encompasses: a control program for the control device which program causes a computer to operate as the foregoing sections (software elements) of the control device so that the control device can be realized by the computer; and a computer-readable storage medium storing the control program therein.

A control device in accordance with a fourth aspect of the present invention is a control device for controlling an electronic apparatus, the control device including: a motion detecting section which detects a viewing motion in which a user views a display device of the electronic apparatus; and a display control section which, in a case where the motion detecting section has detected the viewing motion, causes the display device to display information. The configuration brings about an effect similar to that yielded by the first aspect of the present invention.

A control method in accordance with a fifth aspect of the present invention is a method for controlling an electronic apparatus including at least one display device, the method. including the steps of; (a) detecting a viewing motion in which a user views the at least one display device of the electronic apparatus; and (b) in a case where the viewing motion has been detected in the step (a), causing the at least one display device to display information. The control method brings about an effect similar to that yielded by the first aspect of the present invention.

### [Additional Remarks]

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

10 Wearable terminal (electronic apparatus)
11 Control device
12 Display device
13 Acceleration sensor (motion detecting device)
113 Display detail determining section (display control section)

1. An electronic apparatus comprising:
at least one motion detecting device;
at least one display device; and
at least one control device,
in a case where the at least one motion detecting device has detected a viewing motion in which a user views the at least one display device of the electronic apparatus, the at least one control device causing the at least one display device to display information.

2. The electronic apparatus as set forth in claim 1, wherein the at least one control device estimates a preference of the user in accordance with (i) a frequency of the viewing motion, (ii) a duration of the viewing motion, and (iii) a timing of detection of the viewing motion.

3. The electronic apparatus as set forth in claim 1, wherein, in a case where the at least one motion detecting device has detected a specific motion of the user, the at least one control device either causes the at least one display device to display no information or causes the at least one display device to maintain a current display.

4. A non-transitory computer-readable storage medium storing therein a program for causing a computer to function as the at least one control device of an electronic apparatus recited in claim 1.

5. A control device for controlling an electronic apparatus, the control device comprising:
a motion detecting section which detects a viewing motion in which a user views a display device of the electronic apparatus; and
a display control section which, in a case where the motion detecting section has detected the viewing motion, causes the display device to display information.

6. A method for controlling an electronic apparatus including at least one display device, the method comprising the steps of:
(a) detecting a viewing motion in which a user views the at least one display device of the electronic apparatus; and
(b) in a case where the viewing motion has been detected in the step (a), causing the at least one display device to display information.
